(19) United States
(12) Patent Application Publication
(10) Pub. No.: US 2003/0126150 A1
(43) Pub. Date: Jul. 3, 2003

(54) System and method for building a database to be used in location-based service

(76) Inventor: Jawe Chan, San Jose, CA (US)

Correspondence Address: Jawe Chan, 3072 Baronscourt Way, San Jose, CA, 95132, US

(21) Appl. No.: 10/335,518

(22) Filed: Dec. 30, 2002

Related U.S. Application Data
(60) Provisional application No. 60/346,241, filed on Dec. 31, 2001.

(51) Int. Cl. G06F 7/00

(52) U.S. Cl. 707/100

(57) ABSTRACT

A system and method is for feedback user comments about an object related to user's position,—current, past, or future position. User's position can be determined by user's cell phone (with AGPS), PDA, cell phone with any type of positioning technology, or Notebook Computer with GPS. Said object is a result of an interaction between a user and a location based service system. Said interaction can be a location based auction service, a location based classification system, a location based discuss forum, a system to find a closed by gas station or a nearby hotel or a sales promotion event, or a advertising event from a merchant.

### CROSS-REFERENCE TO RELATED APPLICATIONS

This application claims priority from U.S. Provisional application Ser. No. 60/346,241, filed on Dec. 31, 2001, which is incorporated by reference into this application in its entirety.

### BACKGROUND

1. Field of Invention

This invention relates to an information database building and verification process for location-based service database. Normally, the location-based information building and verification process are done by the information provider and service provider. This invention is to let the information consumer to have a change to involve the database building and verification process. This will ensure the information consumer has a way to feedback the database.

This invention is also related to user profile building process. And the information user's profile can be further used to make the location-based service database more completed and accurate.

It is especially important for mobile information device, like hand-held computer or mobile phone, with position detector device couple with it. The position detector device and method includes network method or hand set method.

This invention is also a furthered development of the patent application serial number US09/253,931 and PCT/US00/03349. The information that the system is accessing includes information about information provider product and service promotion information, merchandise information, event information, weather information, news information, and information about people—personnel information.

2. Description of Prior Art

The mobile information processor, such as notebook computer, handheld computer, in-vehicle computer, electronic organizer, and personal data assistant (PDA), itself is a computer system and is able to process information. Each kind of mobile information processors has different capabilities and features for different purpose. Because of the mobile nature, user is not able to store large amount of information on the mobile information processor. User needs to connect to other system to access other information. Because of the mobile nature, the user will choose wireless connection to access the information on other system. The wireless connection capability on mobile information processor becomes important. Many mobile information processors have either an embedded wireless communication peripheral or an expansion slot for add-on wireless communication card.

Mobile communication device, like mobile phone or pager or Personal Digital Assistant (PDA), is a communication device with a small computer system embedded. The earlier mobile phone has limited capability to process information other than voice message. The earlier pager also is only able to receive the caller's phone number. However, the newer mobile phone and pager has much powerful processing unit and larger display to process and display extra information beyond voice message or phone number. Some of the new mobile device has the capability of voice recognition, web-enabled and larger display.

A mobile information device is mobile equipment that has both information processing and communication capabilities. Both mobile information processor and mobile communication device is mobile information device and eventually has both great processing and great communication capabilities and becomes little or no difference in the near future.

Internet is a revolution technology and contains the richest source of information. Through the Internet, user can access information on the world at the click of a mouse button. User can access information related to a company on the other side of earth at their home. Companies are promoting their product information and services or making direct sale on Internet. Internet is so powerful and convenient to store or retrieve information. Internet naturally becomes the best source of information for mobile information device.

The prior art used to deal with the explosive global information problem is to categorize the information. Most of the search engine on the Internet categorizes the information by the information characteristics. For example, Yahoo Company. Categorizes their database into automobile, travel, computer, political, stock quote, etc. User could choose the category to do the search. This approach might reduce the quantity of information return from a search. However, it is still too much and contains the global information within that category.

Some of company on the Internet further categorizes their information by the geography areas, for example countries or cities. With the geography area category, user could search the information only in a predefined area, which usually is a government district, for example ZIP code area, city, county, state, and country, etc. One of the examples is the Sidewalk WEB site of Microsoft Company. The WEB site provides a utility to locate the stores by given Boolean search criteria and an area, which could be a ZIP code, a city, a county, a state, and a country. After it found the stores, it returns a map and shows the store location by making a mark on the returned map. It has the disadvantage that the searching area is predefined user could not choose as they wish, for example to cross city limit or to narrow down to a shopping mall. Another disadvantage is the information is only limit to store location and without any merchandise information to help shopping.

Some company—go2online.com, airflash.com, geeps.com, vicinity.com, savingumoney.com, timesthree.com, cell-loc.com, lasoo.com, mobileking.com, vicinity, vindigo.com, has recently tried to resolve some of the location-based issues that the industrial has. None of them develop a method for the information user to build the user profile link with location-based database to make the location-based database accurate. The portal information may include any knowledge base information, coupon information, sale information, event information, merchandise information, person information or any other type of information that the information user would like to receive.

These location based company—Go2online.com, airflash.com, geeps.com, atmotion.com, generalmagic.com, geoworks.com, cell-loc.com, timesthree.com, mapinfo.com and gaspricewatch.com provides the information user a steady search or provide the information user unconditional received the information from them. (These companies, some of them are broadcasting the advertisement.) These priors basically are using the merchant as a center. Within that center range, the merchant broadcasting the advertisement or coupon or any product and services promoting material. The user is set up in a way to search and get the advertisement or coupon or any other information.

Another prior art that worth to mention is Global Position System (GPS) receiver. The Global Position System receiver receives the signals from several satellites and then determines its current position. The Global Position System receiver usually build-in a small computer. The computer has a display that could display a simplified map and show the current position on the map. The map is either pre-stored in the computer or could be down load from a remote site through a wireless connection. The computer uses the current position coordination to search a build-in database for local information, for example closest gas stations, hospitals, or restaurants. The build-in database is stored in a memory device of the computer, for example, flash memory or CD-ROM. It has the disadvantages that information might be out date and the searching area may not be selectable.

Some of the prior art such as the stock quote broadcasting through the web phone, pager. Or some of the prior art such as airline ticket availability broadcasting through the web phone, email, and pager. These types of the information searches are general a notification or event that notify the user. Another prior art is ebay.com and aution.yahoo.com. This web site contents a feed back system. This web site has a way to feed back the merchandise information due to complained of merchandise.

A preliminary novelty search of classes 707/1, 701/213, 701/200 in U.S. patents, uncovered U.S. Pat. Nos. 586,799, 5,839,088, 5,802,492. However, none of the prior art shows a way to verify the location-based service database. The first user cans feedback information to be used and reviewed by a 2^{nd} information user.

And the information search can be against information consumer specified searching criteria and searching area, and report the search results including information position through a communication link, such as Internet. Therefore, said information position is further used by routing or navigation application to provide information consumer driving guidance.

### SUMMARY OF INVENTION

A fast and convenient local information search system and method is provided for mobile information device user who is able to search and efficiently retrieve the information corresponding to user's current location from Internet.

When information user searches the location-based service database, information user will get the search result and can go to the place of the search results. If the information user finds the cheapest merchandise and go to that store, he may find the cheapest merchandise is not what he expected in term of the price or quality. The information user can then feed back the comments to the server—link to the merchandise database. This will be a feedback loop for the server to realize the accuracy of the information provider's information and also the needs of the database.

So, the next information user found merchandise with user comment (user rating), he will know the accuracy of the merchandise database. If this merchandise has an error—with low user rating and lots of user complained, this merchandise will be shown on the database and the next information user may not go to found this particular merchandise. Following is an example to show how to use it.

Ex. The information user enter search requirements to use his GPS (Global Position System) based cell phone, the information user is then went to check out the cheapest nearby YAMAHA piano. When he goes there he may find,

1. The price in the store is not it appears to be the price that was on the database.

2. The location of the piano is not the right location and price is not the right one.

3. The quality of the piano is not the right piano. The piano was a used one or broken box, or the key is not in the right tune.

All the user comments can only be entered if the user has been in that place since the information provider have updated the information. The comments can be enter when the information user is near by that particular merchandise or he can enter the comments after he come back the home or office. The cgi (common gateway interface) or application program can check if the information user has been nearby the merchandise or not. (Less then 500 yards). The server will reward the information user if the information user enter his comments into the system that help out other information user to make the database more accurate or richer and more useful.

Normally the information user can get on the network by information user's first computer. The first computer can be a cell phone, a PDA—Personal Digital Assistant, a smart phone from Microsoft, or a Palm enabled phone, or a mini computer. The first computer will also be coupled a method to determine the first computer current position. The position is either be entered by the information user or a computer hardware mechanism such as wireless position system or a Global Position System. The information user's position is then send to a second computer, a server computer, through network. Once the server computer received the information user's current position, the server computer will couple the information user's current position and other criteria for further application indicated by the method below. Once the method is determined, the system will operate according to the method and send the results back to the information user. The following paragraph will determine the method may be used or the information database that will be searched by the information user.

The invention based on a local information system that is included 2 folds. One is information provider to provide information. Another one is the information user consumes information and also try to correct or verify the provided information. In the mean time the information user can provide information to the server also to help out the database building process. The comment user can or cannot upload is based on the user's location. If the user located near by the objects—stores or merchandise (examples: within the object 100 feet radius)—the user can be allowed by the system to make a comment about this object.

This invention can be implemented by a very complicated database system, such as ORACLE database or SQL database system. Or it is simply implemented using some of the PERL program. (CGI—Common Gateway Interface). The CGI program can be easily found in www.cgi-resoureces.com. It is for a person in the skill of the art easily enough to implement an auction or comparison-shopping web site or classification website with these share ware program. It is then for the system to read back the user location from a GPS or any other Automatic Location Identifier along with the user input to determine if the user can upload the user comment or not. These are easily enough for the person in the skill of the art to simply put a condition statement in the PERL program to implement this invention. Again, the database—merchandise or store—need to associate a position which the merchandise or store is located.

The position history of a user can also be determined by GPS. Amount of time which user has spent in the vicinity of an area can be determined. Normally AGPS updated position every 5 minutes. If user's position history has 5 positions in the 100 feet radius of the object, than the user has been spent 25 minutes to look at the object. Therefore, the user might have a better comment than the rest of the user. The server system can allow the user to upload his or her comments.

### OBJECTS AND ADVANTAGES

Accordingly, besides the objects and advantages of the system and method for searching local information describes in my above patent, several objects and advantages of the present invention are:

(a) To provide the information to the information user according to the information user position.

(b) To provide the mobile information to the mobile information user according to the mobile information user's position history.

(c) To provide a way for the information user to feed back the data to the system.

(d) To provide a way for the information user to view other information user's comment on object based on their physical location.

### METHOD OF OPERATION AND FLOW CHART

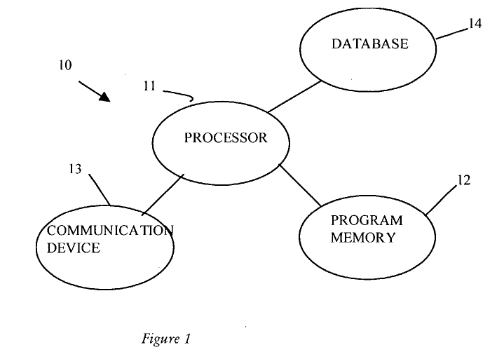

### DESCRIPTION—FIGS. 1 to 9

FIG. 1 illustrates an example of a server computer system 10 for storing and retrieving merchandise data in accordance with the invention. Computer system 10 comprises a processor 11, program memory 12, a communication device 13, and a merchandise database 14. The communication device 14 might be a modem or a high-speed leased line router. In the embodiment of FIG. 1, system 10 is an information server, and processor 11 is in data communication with the various end-user computer systems via the Internet. However, in other embodiments, the invention could be implemented with a processor having multiple modems to receive calls directly from end-user computer systems and establish the data communication via the modems and public phone line. The database 14 may include the position coordinates of the merchandise (or e-coupon, coupon or product sales event), price of merchandise (or e-coupon, coupon or product sales event), and an identification of merchandise (or e-coupon, coupon or product sales event).

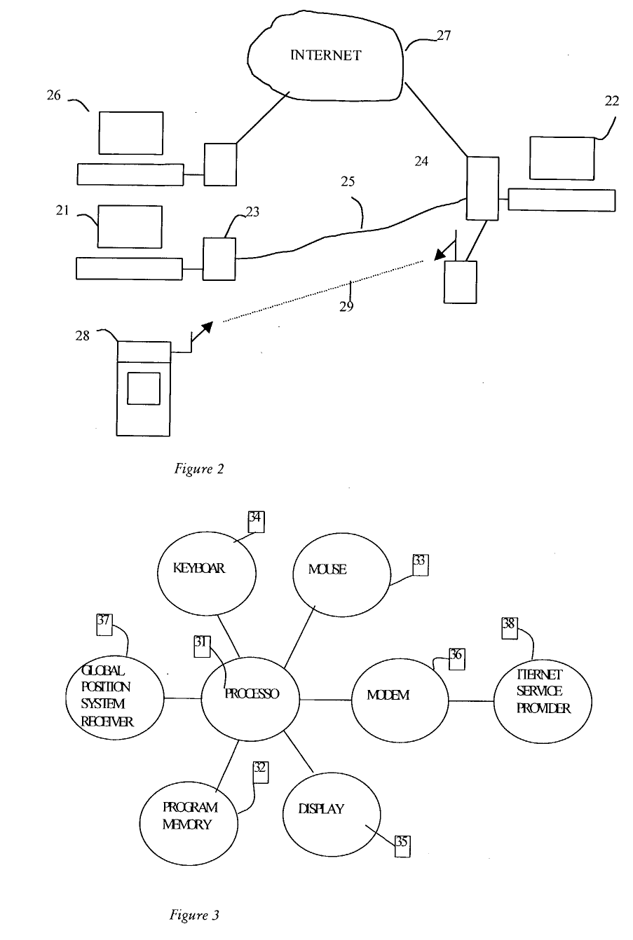

In FIG. 2, it shows end-user computers communicate with server computer in variety ways. End-user computer system 21 connects to server computer system 22 via modem 23 and modem 24 through phone line 25. Another example is that end-user computer system 26 also connected to server computer system 22 through Internet 27. End-user computer system 28 connects to server computer system 22 through radio frequency link 29.

An example of a suitable computer system 10 is one operating in accordance with the Sun Microsystems Solaris operating system. Processor 11 may be any general-purpose processor having a CPU, RAM, ROM, and I/O circuitry.

To explain further, one aspect of the invention is the use of computer system 10 to access product promotion information (e-coupon, coupon or product sales event) and business directory information database 14 to provide a user with product promotion information (e-coupon, coupon or product sales event) within a given area by the user's path history. In the example of this description, database 14 is a centralized database system and stores the data about product promotion information (e-coupon, coupon or product sales event) and business directory information in the worldwide area. However, in other embodiments, database 14 might be implemented as a distributed database system, which stores the information in several computer systems and might locate in different areas. Each of distributed databases might store data about merchandise information in a local area, such as a particular state or country.

Database 14 of the embodiment is implemented in a relational database manner. Each of product promotion information (e-coupon, coupon or product sales event) and business directory information is organized as a record in the database to describe a merchandise, having a filed for each product promotion information (e-coupon, coupon or product sales event) and business directory information record to describe the merchandise, for searching of records of product promotion information (e-coupon, coupon or product sales event) and business directory information describing that product promotion information. Another field in each of product promotion information (e-coupon, coupon or product sales event) record is a position field. The position field is a position coordination of the merchandise. The position coordination is comprised of latitude and longitude of Global Position System coordination. It could also contain altitude of Global Position System coordination when it is necessary. The database 14 could also be arranged in an object-oriented manner for attribute searching.

FIG. 3 illustrates an example of an end-user computer system 30 for retrieving merchandise information in accordance with the invention. Computer system 30 comprises a processor 31, program memory 32, a mouse 33 and keyboard 34 for user input, a display 35, a modem 36, Global Position System receiver 37, and Internet Service Provider (ISP) 38. In the embodiment of FIG. 2, system 30 is an end-user computer system, and processor 11 is in data communication with an Internet Service Provider 38 first and then the Internet Service Provider transmits the data to the computer system in FIG. 1 via the Internet. However, in other embodiments, the invention could be implemented with a processor having a modem call directly to the computer systems in FIG. 1 and establish the data communication link via the modems. Or, the invention could be implemented such that the end-user computer system in FIG. 2 and server computer system in FIG. 1 is in a local network (LAN) or a wide area network (WAN).

In the embodiment of FIG. 2, Global Position System receiver 37 is a positioning instrument, and is used as current position coordination input device for computer system 30 in FIG. 2. However, in other embodiment, user of computer system 30 could input the position coordination from other input device, for example from a keyboard 34, if the user knows his or her current position or like to search merchandise information at other location.

An example of a suitable end-user computer system 30 is one operating in accordance with the Microsoft WINDOWS operating system. Processor 11 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 11 is programmed to execute a process to help the user and take user's input.

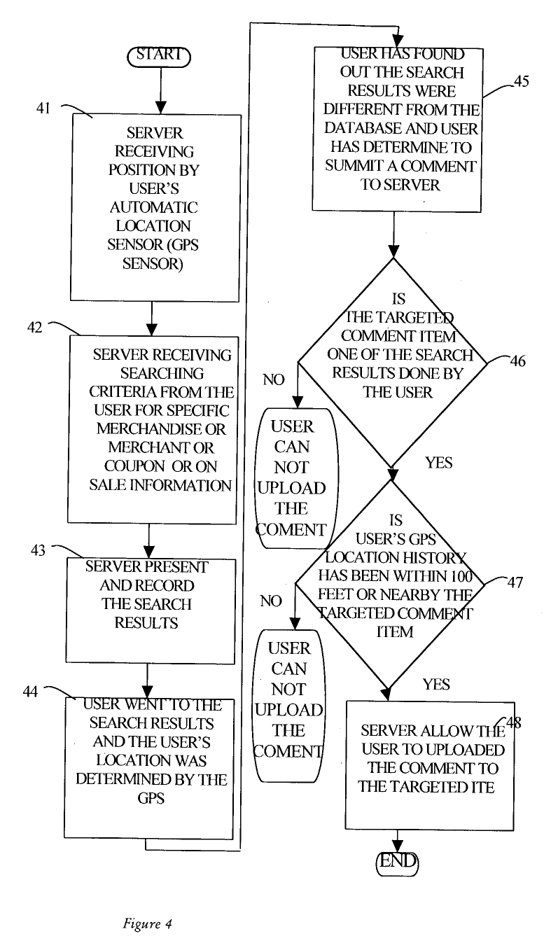

FIG. 4 illustrates the flow chart of the location trace was used by the system when the user doing or receiving information from the database.

FIG. 4 illustrates the flow chart of the location based service database building process. The database can be merchandise or store.

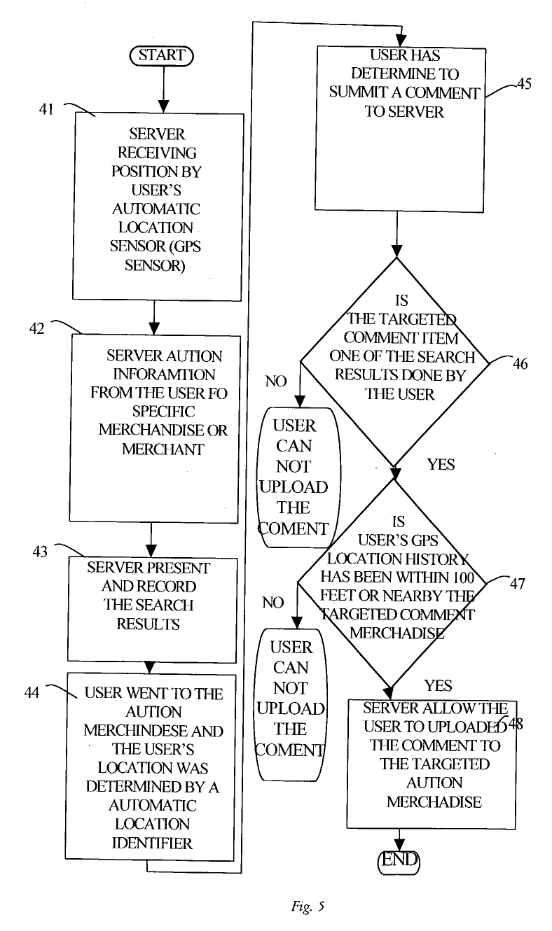

FIG. 5 illustrates the flow chart of the location based auction service data based building process. The database is an auction merchandise database.

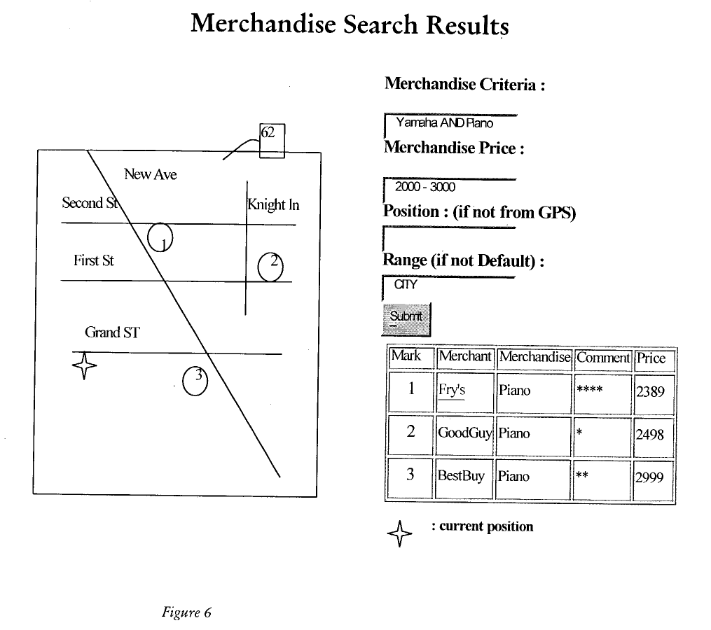

FIG. 6 illustrates the user interface of the location based searching system. The user is searching for merchandise with certain price criteria in mind. The can be the best price or can be sales items or any other price criteria.

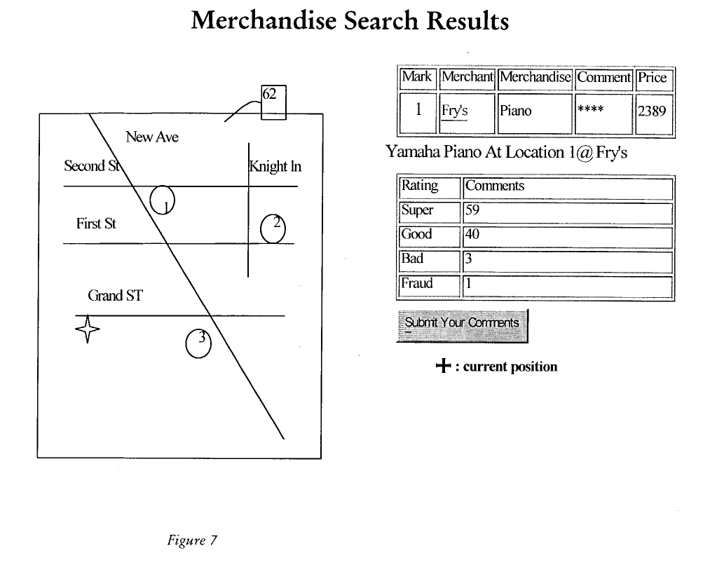

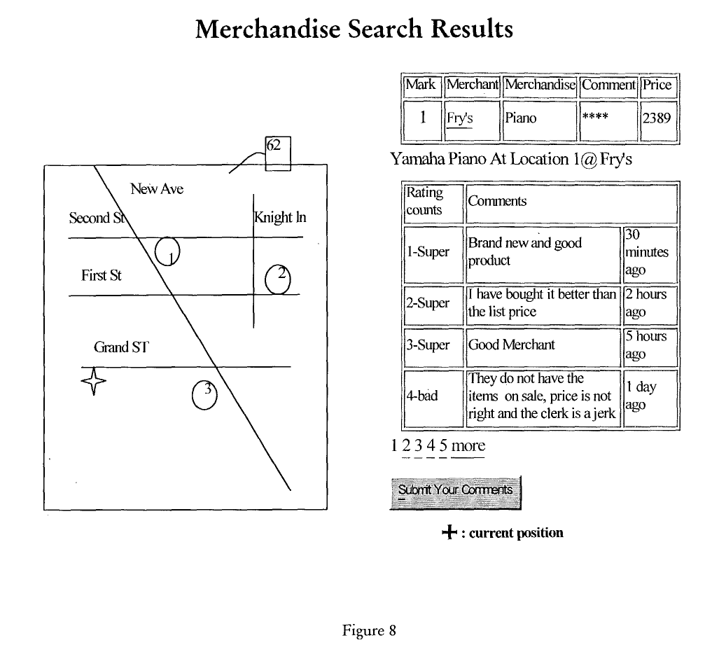

FIG. 7 illustrates a searching result of the user interface of the location based searching system. User click on Fry's to go to FIG. 8.

FIG. 8 illustrates a searching result of the user interface of the location based searching system with one of the merchant's rating done by the user.

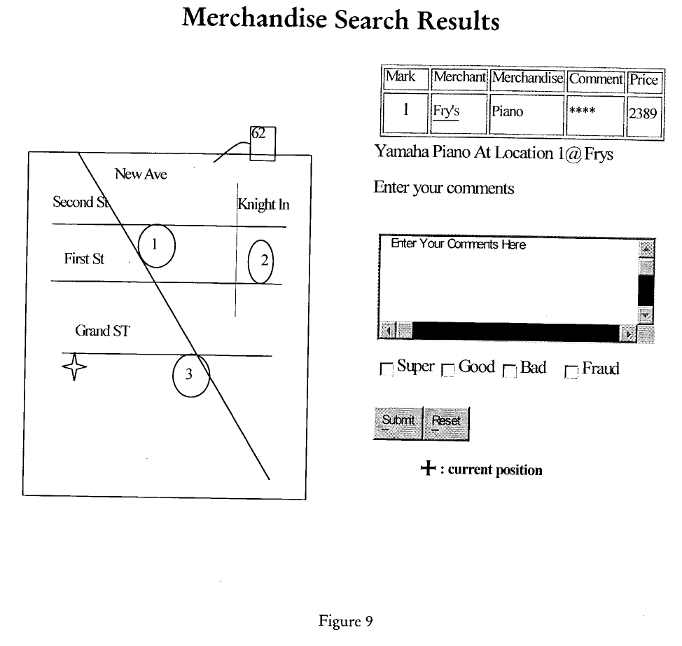

FIG. 9 illustrates a user interface of the location based searching system which the user can input the user comment about one of the merchandise.

### POSITION TECHNOLOGY

Position Technology mention in this patent application can be but not limited to the following technology

1. Satellite-Based Technology for Location Services

=>assisted GPS, Galileo, GLONAS, other satellite-based techniques, integration with the phone

2. Terrestrial-Radio-Based Technology for Location Services

=>angle of arrival (AOA), time of arrival (TOA), time difference of arrival (TDOA), hybrid methods, integration with the phone

### CONCLUSION, RAMIFICATIONS, AND SCOPE

This location base information feed back system can be implemented for location based auction service, location based classification system and location based forum system.

A system and method is for feedback user comments about an object. Said object is a result of an interaction between a user and a location based service system. Said interaction can be a location based auction service, a location based classification system, a location based discuss forum, a system to find a closed by gas station or a nearby hotel or a sales promotion event, or a advertising event from a merchant. The merchant can be associated with a position.

Thus the scope of the invention should be determined by the appended claims and their legal equivalents, rather than by the examples given.

I claim:

1. A method for updating a database, comprising the steps of:
determining user physical position;
receiving the physical position information;
determining the physical position within vicinity area of an object; and
updating user's comment about the object into a database.

2. The method of claim 1, wherein the determining user physical position is by user's Automatic location Instrument.

3. The method of claim 2, wherein the user's Automatic location Instrument is user's Global Positioning Receiver.

4. The method of claim 2, wherein the user's Automatic location Instrument is user's Assisted Global Positioning System Receiver.

5. The method of claim 1, wherein the receiving and updating are performed over a communication link.

6. The method of claim 1, wherein the acts recited in claim 1 are performed using a stand-alone computer.

7. The method of claim 1, further comprising:
wherein the updating is performed in response to receiving the information related to the object.

8. The method of claim 1, further comprising:
wherein the updating user's comment is adding the object's rating by the user.

9. The method of claim 1, wherein the database is a hotel reservation database.

10. The method of claim 1, wherein the database is a gasoline station database.

11. The method of claim 1, wherein the database is a coupon database.

12. The method of claim 1, wherein the database is a sales promotion event database.

13. The method of claim 1, wherein the database is a real estate property database.

14. The method of claim 1, wherein the database is a classification database.

15. The method of claim 1, wherein the database is an auction database.

16. The method of claim 1, wherein the database is an advertising database.

17. The method of claim 1, wherein the vicinity area is constructed by an area constrain and object's physical position.

18. The method of claim 17, wherein vicinity area is 100 feet radius center by the object.

19. The method of claim 1, wherein the vicinity area is the street block which the object is located.

20. The method of claim 1, wherein the updating is result of the user's is inside the vicinity area of the object.

21. The method of claim 1, wherein the vicinity area is defined by the user.

22. The method of claim 1, wherein the user's position is determined by Terrestrial-Radio-Based Technology.

23. The method of claim 1, wherein the user's position is determined by Satellite-Based Technology.

24. The method of claim 1, further comprising:
determining amount of time the user is in the vicinity area of the object.

25. A computer system comprising a computer connected to a computer network, and computer instructions executed by the computer for performing the acts in claim 1.
